(19) United States
(12) Patent Application Publication
(10) Pub. No.: US 2002/0029409 A1
(43) Pub. Date: Mar. 14, 2002

(54) Protective element particularly for cycling shorts

(75) Inventor: Stefano Coccia, Conegliano (IT)

Correspondence Address: MODIANO & ASSOCIATI, Via Meravigli, 16, MILANO, 20123, IT

(73) Assignee: DE MARCHI SPORT S.R.L.

(21) Appl. No.: 09/910,809

(22) Filed: Jul. 24, 2001

(30) Foreign Application Priority Data
Aug. 10, 2000 (IT) TV2000U000035

(51) Int. Cl. A62B 17/00; A41D 13/12; A41D 1/00

(52) U.S. Cl. 2/456; 2/69

(57) ABSTRACT

A protective element, particularly for cycling shorts, which is constituted by a double-stretch support with which at least one double-stretch padding is associated.

### BACKGROUND OF THE INVENTION

The present invention relates to a protective element particularly for cycling shorts.

Currently, in the practice of cycling it is known to use shorts, made of a material which may be partially elasticized, which cling snugly to the body and are usually worn without underwear.

The main problem for the athlete is the fact that during races or training the crotch is subjected to continuous stresses, since such part of the body is continuously in contact with the saddle and thus is subjected to all the shocks produced by the unevenness of the ground and by the vibrations transmitted by the bicycle frame.

Accordingly, localized reddening is produced which can degenerate into cuts or blisters which make it difficult if not impossible to practice the sport.

As a partial solution to these drawbacks, it is known to use shorts inside which a padding constituted by a cloth of suitable thickness and made of textile material is sewn internally at the crotch.

However, this solution is not ideal, because although the thickness of the padding can initially offer relief, it has been found that it tends to overheat the crotch and most of all that continuous mutual slippage between the crotch and the padding occurs, also due to sweating, which very soon eliminates the initial benefits.

Moreover, it has been found that the crotch rests on the padding, and the padding rests on the saddle, forming compression concentration regions which depend on the stresses applied during sports practice and can even cause the onset of soreness.

As a partial solution to these drawbacks, it is also known to provide shorts with which a bottom provided with multiple chambers is associated at the crotch region by sewing, the chambers being arranged laterally to a longitudinal axis of the saddle, being mutually distinct and defining diversified supporting regions for the crotch.

Although they solve some of the above mentioned drawbacks, both this and the preceding solutions suffer the drawback due to the fact that the padding or bottom are made of substantially rigid or scarcely elastic materials, in a percentage which ranges between approximately 0% and 2%, thus rendering useless any small elastic deformation of the fabric that constitutes the shorts.

This fact restricts considerably the freedom of movement of the body; moreover, the greater the padding, the thicker it becomes, further increasing overall rigidity and weight, thus hindering movements even more.

Moreover, a “diaper” effect is produced: when the cyclist dismounts from the bicycle and walks normally, he is thus further hindered in his movements by the presence of the padding or bottom.

A reduction in the padding can provide greater freedom of movement but considerably reduces the ability to protect from impacts and vibration on the saddle.

Moreover, the use of paddings or bottoms has been found to be subject, during the practice of cycling, to formation of folds, owing to the arc-like shape of the crotch, the folds producing additional irritation regions, both longitudinally and transversely to the crotch region.

Finally, it is noted that the use of paddings in known bottoms affects the entire extension of the product and this again entails an increase in the “diaper” effect.

In all of the prior art, the padding is in fact present along the entire extension of the product; even in the method that uses differentiated thicknesses, the flat padding part is obtained by compressing the padding, which thus also affects the apparently flat portions of the bottom.

### SUMMARY OF THE INVENTION

The aim of the present invention is to eliminate the drawbacks of the cited prior art, by providing a protective element for cycling shorts which allows to achieve optimum comfort at the crotch together with great freedom of movement both on the saddle and off the saddle and with an overall lightness of the shorts, thus avoiding the noted “diaper” effect.

Within this aim, an object of the invention is to provide a protective element for cycling shorts which allows to increase the comfort for the user while maintaining the features of lightness and modest thicknesses.

Another object is to provide a protective element for cycling shorts which in addition has low costs, is structurally simple, reliable and safe in use.

This aim and these and other objects which will become better apparent hereinafter are achieved by a protective element, particularly for cycling shorts, characterized in that it is constituted by a double-stretch support with which at least one double-stretch padding is associated.

### BRIEF DESCRIPTION OF THE DRAWINGS

Further characteristics and advantages of the invention will become better apparent from the detailed description of a particular embodiment thereof, illustrated only by way of non-limitative example in the accompanying drawings, wherein:

FIG. 1 is a plan view of the protective element according to the present invention;

FIG. 2 is a partially sectional view of a pair of shorts with which the protective element of the invention is associated;

FIG. 3 is a sectional view, taken along the line III-III of FIG. 1;

FIG. 4 is a view of the protective element subjected to deformation substantially longitudinally thereto;

FIG. 5 is a view of the protective element subjected to deformation substantially transversely thereto.

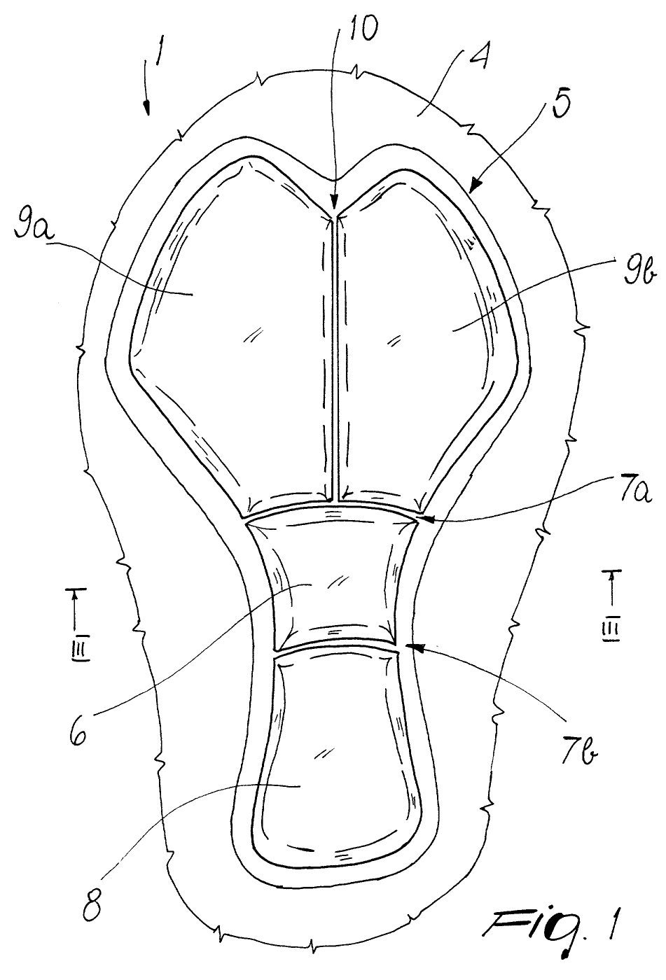

### DESCRIPTION OF THE PREFERRED EMBODIMENTS

With reference to the figures, the reference numeral 1 designates a protective element which is applied in particular at a region 2 of the crotch of cycling shorts 3.

The protective element is constituted by a support 4 which is made of double-stretch material and therefore allows its elongation along multiple planes, including planes at right angles to each other.

The support 4 can have an elasticity of up to 30-40% and can thus be constituted for example by a fabric known by the trademark Lycra with microfibers.

The support 4 can in turn be associated, by known means, with the shorts or can directly constitute the material of which the shorts are made.

At least one double-stretch padding 5 of the open-cell high-density type, having approximately two or three times the density normally used in conventional bottoms, in order to have greater protection and lower thickness or greater protection for an equal thickness, is associated at the support 4.

The double-stretch padding 5 must therefore have the characteristic of being deformable in multiple directions, including directions at right angles to each other, and a density between 55 and 95 kg/m³.

Preferably, a density of 65 kg/m³, much higher than the density already used in the known art, which is approximately 20 kg/m³, can be used.

The thickness can be between 5 and 12 mm, preferably 10 mm.

The double-stretch padding 5 is applied only at the points that rest on the saddle; no padding is present in the other areas of the support.

This allows to avoid useless space occupation, stiffening and any further reddening and thus allows to provide maximum elasticity.

The double-stretch padding 5 is advantageously constituted by a first central element 6 which is arranged approximately at the tangent to the imaginary curved line of the crotch.

A second element 8 is formed at the front, and two third elements 9a and 9b are formed at the rear, at the transverse ends of the first central element 6, with first flat regions 7a and 7b interposed.

The second element 8 thus affects the front region of the crotch, while the third elements 9a and 9b are mirror-symmetrical with respect to a central plane which lies longitudinally to the double-stretch padding 5 and are mutually divided by the presence of a second flat region 10 which accordingly lies at said longitudinal central plane.

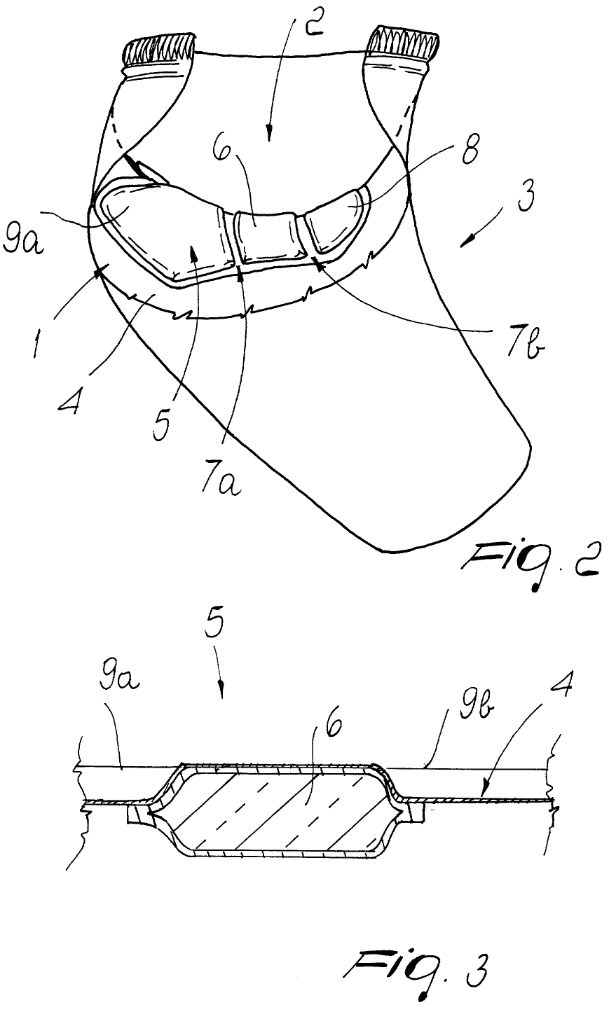

The first flat regions 7a and 7b, and therefore the dimensions of the respective first central element 6, second element 8 and third elements 9a and 9b, are such that, as shown in FIG. 2, they are formed at the folding region of the double-stretch padding 5, which accordingly is not affected at the first, second and third elements by any deformation during use.

The double-stretch padding 5 is associable at the support 4 preferably by a high-frequency or thermoformation or ultrasound application process; the absence of stitched seams allows to prevent any reddening due to friction against the double-stretch padding.

The application of the support 4 to the shorts, if required, can occur by sewing or by high-frequency or thermoformation or ultrasound methods.

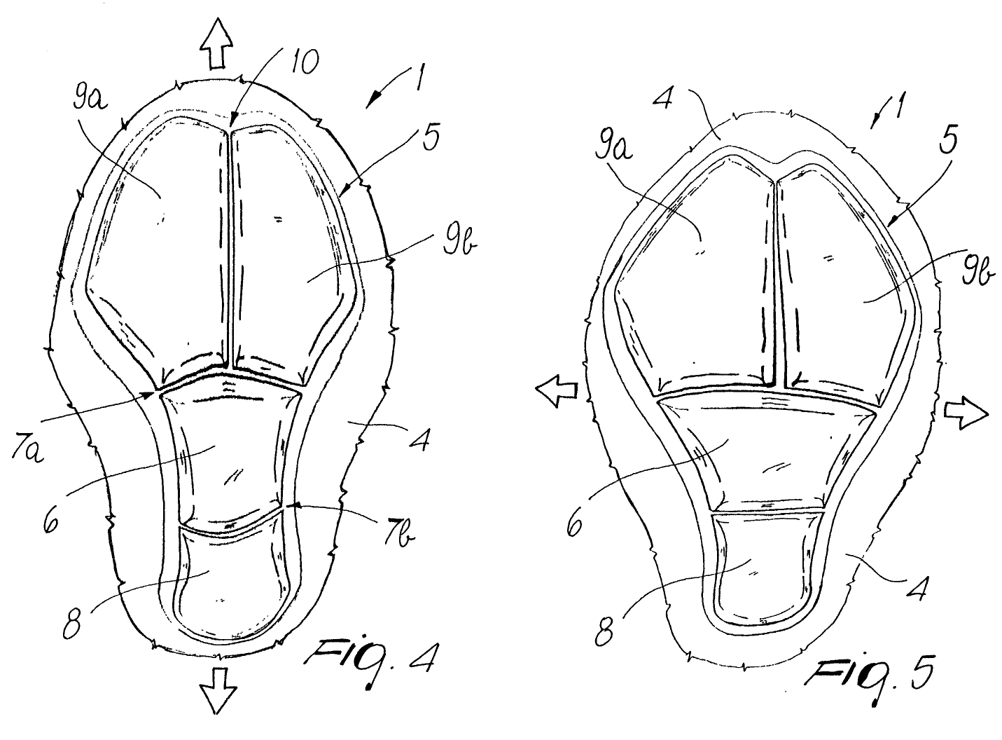

It has thus been found that the invention has achieved the intended aim and objects, a protective element having been obtained which, applied to a pair of shorts, adapts in an optimum manner to the crotch during sports practice or during walking thanks to the fact that the support and the corresponding padding can undergo deformations along axes which can even be mutually perpendicular, as shown in FIGS. 4 and 5, while maintaining optimum protection of the crotch, all this with very modest thicknesses and weights.

Accordingly, one achieves maximum protection, excellent fit and great freedom of movement both on the saddle and off it, together with a lightness which eliminates the so-called “diaper” effect.

The particular arrangement of the flat regions as well as the elements that constitute the double-stretch padding 5 also allows to maintain optimum comfort if the bending of the protective element 1 is extreme, since the folds form at the flat regions 7a, 7b and 10.

The particular method for coupling the double-stretch padding to the support allows to maintain a high level of comfort for the user, thus eliminating any possible reddening due to friction.

The materials used, as well as the dimensions, may of course be the most pertinent according to the specific requirements.

The disclosures in Italian Utility Model Application No. TV2000U000035 from which this application claims priority are incorporated herein by reference.

What is claimed is:

1. A protective element, particularly for cycling shorts, comprising a double-stretch support with which at least one double-stretch padding is associated.

2. The protective element according to claim 1, wherein said support made of double-stretch material can elongate along multiple planes, including mutually perpendicular ones.

3. The protective element according to claim 1, wherein said support has an elasticity of up to 30-40%.

4. The protective element according to claim 1, wherein said support is associatable with a pair of shorts.

5. The protective element according to claim 1, wherein said at least one double-stretch padding is an open-cell high-density padding.

6. The protective element according to claim 1, wherein said double-stretch padding is deformable in multiple directions, including mutually perpendicular directions.

7. The protective element according to claim 1, wherein said double-stretch padding has a density between 55 and 95 kg/m³.

8. The protective element according to claim 1, wherein said double-stretch padding has a density of 65 kg/m³.

9. The protective element according to claim 1, wherein said double-stretch padding has a thickness of 5 to 12 mm.

10. The protective element according to claim 1, wherein said double-stretch padding has a thickness of 10 mm.

11. The protective element according to claim 1, wherein said double-stretch padding is constituted by a first central element which arranges itself approximately at the tangent to an imaginary curved line of a crotch of a pair of shorts.

12. The protective element according to claim 11, wherein a second element is formed at the front, and a pair of third elements are formed at the rear, with first flat regions interposed, at transverse ends of said first central element.

13. The protective element according to claim 12, wherein said second element affects the front region of the crotch while said third elements are mirror-symmetrical with respect to a central plane which is longitudinal to said double-stretch padding and are mutually divided by the presence of a second flat region which accordingly lies at said longitudinal central plane.

14. The protective element according to claim 12, wherein said first flat regions, and therefore the dimensions of said first central element, said second element and said third elements are such that they are formed at a folding region of said double-stretch padding that is not affected, at said first, second and third elements, by any deformation during use.

15. The protective element according to claim 1, wherein said double-stretch padding is associable at said support by a high-frequency or thermoformation or ultrasound application method.

16. The protective element according to claim 1, wherein said double-stretch padding is applied only at points where resting on a saddle of a bicycle occurs and no padding is provided in the other areas of said support.

17. Shorts, particularly for cycling, comprising a protective element constituted by a double-stretch support with which at least one double-stretch padding is associated.

18. The shorts according to claim 17, wherein said shorts and said support are made of the same material.
